(19) United States
(12) Patent Application Publication
(10) Pub. No.: US 2026/0113270 A1
(43) Pub. Date: Apr. 23, 2026

(54) Small Cell with Integrated User Plane Function

(71) Applicant: DISH Wireless L.L.C., Littleton, CO (US)

(72) Inventor: In-Kyung Kim, Highlands Ranch, CO (US)

(21) Appl. No.: 18/921,458

(22) Filed: Oct. 21, 2024

(51) Int. Cl. H04L 45/42; H04W 40/02

(52) U.S. Cl. CPC H04L 45/42; H04W 40/02

(57) ABSTRACT

Various arrangements of cellular network base station systems are presented. The system can include a cellular base station hardware platform configured to execute gNodeB functions. The platform can also execute a user plane function (UPF). The UPF is executed in isolation from the gNodeB functions. The UPF can route Internet communications for pieces of user equipment (UEs) in wireless communication with the cellular base station hardware platform to the Internet without passing through a cellular network core.

### BACKGROUND

In a 5G New Radio (NR) cellular network, various network functions (NFs) of the cellular network are hosted by the core. One of these functions can be the user plane function (UPF). The UPF serves to manage packet routing and forwarding, quality of service (QoS) management for communications between pieces of user equipment (UE) and routing with one or more external data networks, such as the Internet. Therefore, when a user accesses a website or application via a UE, the UPF manages data communication between the cellular network and the Internet in order to communicate with the website's server.

Accordingly, in order for the UE to access various websites, use various network-enabled applications, or otherwise access information on the Internet, communications between the UE and the Internet are routed via a UPF of the cellular network's core. Such an arrangement, however, can introduce latency and consume communication bandwidth between the base station of the cellular network and the cellular network core.

### SUMMARY

Various embodiments are described related to a cellular network base station system. In some embodiments, a cellular network base station system is described. The system may comprise a cellular base station hardware platform configured to execute gNodeB functions and a user plane function (UPF). The cellular base station hardware platform may be configured to execute the UPF in isolation from the gNodeB functions. The cellular base station hardware platform may be configured to route Internet communications for pieces of user equipment (UEs) in wireless communication with the cellular base station hardware platform via the UPF to the Internet without passing through a cellular network core.

Embodiments of such a system may include one or more of the following features: the cellular network core may be hosted remotely from the cellular base station hardware platform. The cellular network core may host an access and mobility management function (AMF). The gNodeB functions may communicate via an N2 interface with the AMF in the cellular network core and an N3 interface with the UPF hosted by the cellular base station hardware platform. The cellular network core may be hosted on a public cloud computing platform. A first processor may be used for the UPF that may be distinct from a second processor used to execute the gNodeB functions. A first memory block of the cellular base station hardware platform may be defined for the UPF and a second memory block of the cellular base station hardware platform may be defined for the gNodeB functions. The system may further comprise a second cellular base station hardware platform configured to execute gNodeB functions and a second UPF. The cellular base station hardware platform may be configured to execute the second UPF in isolation from the gNodeB functions. The cellular base station hardware platform may be configured to route Internet communications for UEs in wireless communication with the second cellular base station hardware platform via the second UPF to the Internet without passing through the cellular network core. The cellular base station hardware platform and the second cellular base station hardware platform communicate with a network via a switch. The system may further comprise a secondary access point. The secondary access point may be in wireless communication with the cellular base station hardware platform and access the UPF to route Internet communications for one or more UEs in wireless communication with the secondary access point. The gNodeB functions of the cellular base station hardware platform may be part of a small cell.

In some embodiments, a method for using a cellular base station hardware platform is described. The method may comprise receiving, by a small cell that may be hosted by the cellular base station hardware platform, a network access request. The small cell may perform gNodeB functions. The method may comprise routing, by the small cell, the network access request to a cellular network core hosted remotely from the cellular base station hardware platform. The method may comprise receiving, by a user plane function (UPF) hosted by the cellular base station hardware platform, data corresponding to the network access request from the cellular network core. The method may comprise, in response to the data corresponding to the network access request, accessing, by the UPF, remote services via an Internet connection without the UPF communicating through the cellular network core.

Embodiments of such a method may include one or more of the following features: the cellular network core may comprise an access and mobility management function (AMF). Routing, by the small cell, the network access request to the cellular network core may comprise routing the network access request to the AMF, and receiving the data corresponding to the network access request may be received from the AMF of the cellular network core. The gNodeB functions of the small cell may communicate via an N2 interface with the AMF in the cellular network core and an N3 interface with the UPF hosted by the cellular base station hardware platform. The cellular network core may be hosted on a public cloud computing platform. A first processor may be used for the UPF that may be distinct from a second processor used to execute the gNodeB functions. A first memory block of the cellular base station hardware platform may be defined for the UPF and a second memory block of the cellular base station hardware platform may be defined for the gNodeB functions. The method may further comprise receiving, by a second small cell that may be hosted by a second cellular base station hardware platform, a second network access request. The small cell performs gNodeB functions. The method may further comprise routing, by the second small cell, the network access request to the cellular network core hosted remotely from the cellular base station hardware platform. The method may further comprise receiving, by a second UPF hosted by the second cellular base station hardware platform, second data corresponding to the second network access request from the cellular network core. The method may further comprise, in response to the second data corresponding to the second network access request, accessing, by the second UPF, remote services via the Internet connection without the second UPF communicating through the cellular network core. The cellular base station hardware platform and the second cellular base station hardware platform communicate with the Internet connection via a switch. The method may further comprise communicating, by a secondary access point, with the UPF. The secondary access point may be in wireless communication with the cellular base station hardware platform and accesses the UPF to route Internet communications for one or more UEs in wireless communication with the secondary access point.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a cellular network system that includes a small cell with an integrated UPF.

FIG. 2 illustrates an embodiment of a cellular network core.

FIG. 3 illustrates an embodiment of a cellular network core implemented on a public cloud hosting system.

FIG. 4 illustrates an embodiment of a cellular network system that includes multiple small cells with integrated UPFs.

FIG. 5 illustrates an embodiment of a cellular network system that includes small cell with multiple secondary APs using a UPF integrated with the small cell.

FIG. 6 illustrates an embodiment of a method for using a small cell with an integrated UPF.

### DETAILED DESCRIPTION

A “small cell” refers to a relatively low-powered cellular network radio access node compared to a cellular base station that provides cellular network access over a significant geographic area. A small cell may be installed to provide cellular network access in a specific area or building. For example, a small cell may be installed within a factory in order to provide cellular network access to equipment or, more generally, pieces of UE (“UEs”) located within and nearby the factory. Multiple small cells can be installed in a general location, such as across multiple buildings at a facility. In some arrangements, a small cell may be configured to provide cellular network access to only one particular entity's UEs.

When a UE is to access a remote service via the Internet, in a conventional arrangement, communications would be routed from the small cell to a cellular network core, which includes a UPF. The UPF would then facilitate the communications being routed to the Internet. As detailed herein, rather than having the UPF located at the cellular network core, the UPF can utilize the same hardware as the small cell. Therefore, rather than communications having to be routed to the cellular network core, communications to be managed and routed by the UPF can be handled locally and routed to the Internet without requiring the communication to be routed through the core.

By having the UPF located locally at the small cell, various advantages can be realized. For example, latency in communication between a UE and a remote service accessible via the Internet can be decreased. Bandwidth may additionally or alternatively be increased due to communications not needing to first go to the cellular network core. The amount of processing needing to be performed by the core can also be reduced by offloading the UPF.

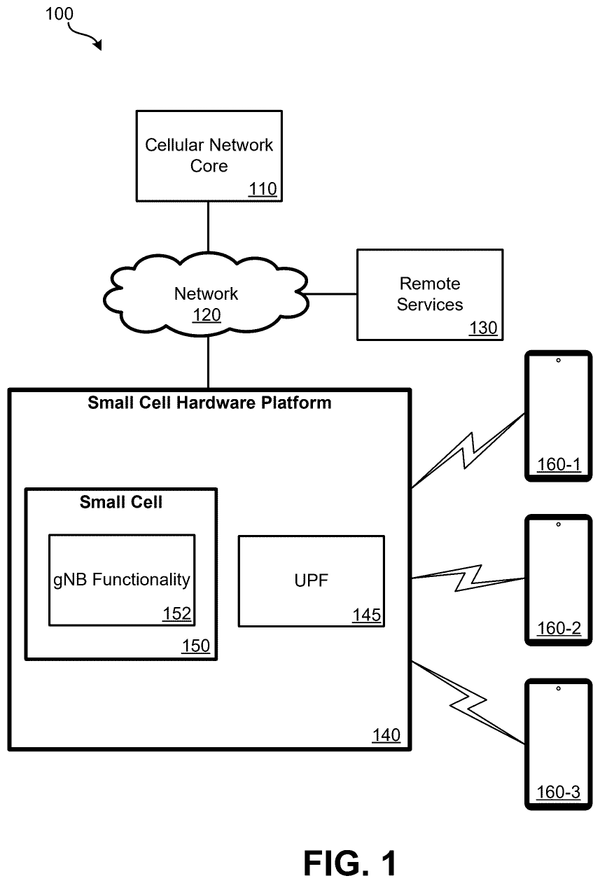

Further detail regarding such embodiments is provided in relation to the figures. FIG. 1 illustrates an embodiment of a cellular network system 100 (“system 100”) that includes a small cell with an integrated UPF. System 100 can represent a portion of a cellular network that additionally includes many base stations. System 100 can include: cellular network core 110; network 120; remote services 130; small cell hardware platform 140; and UEs 160 (e.g., 160-1, 160-2, 160-3).

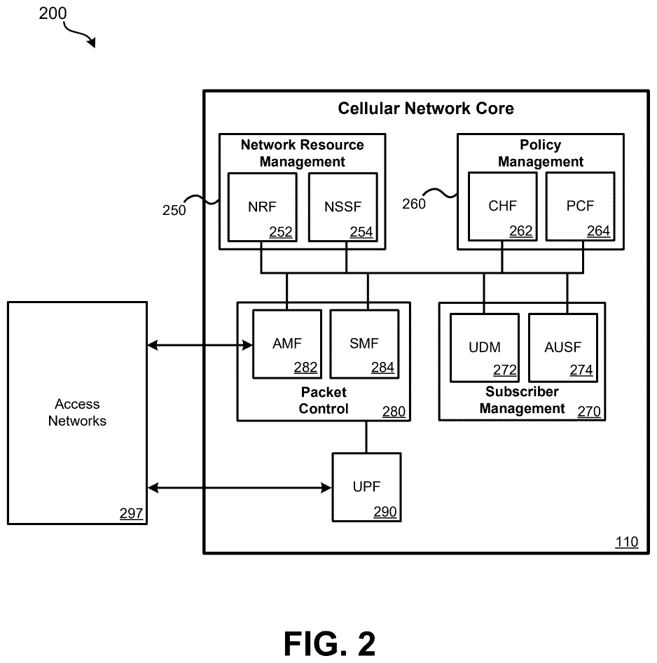

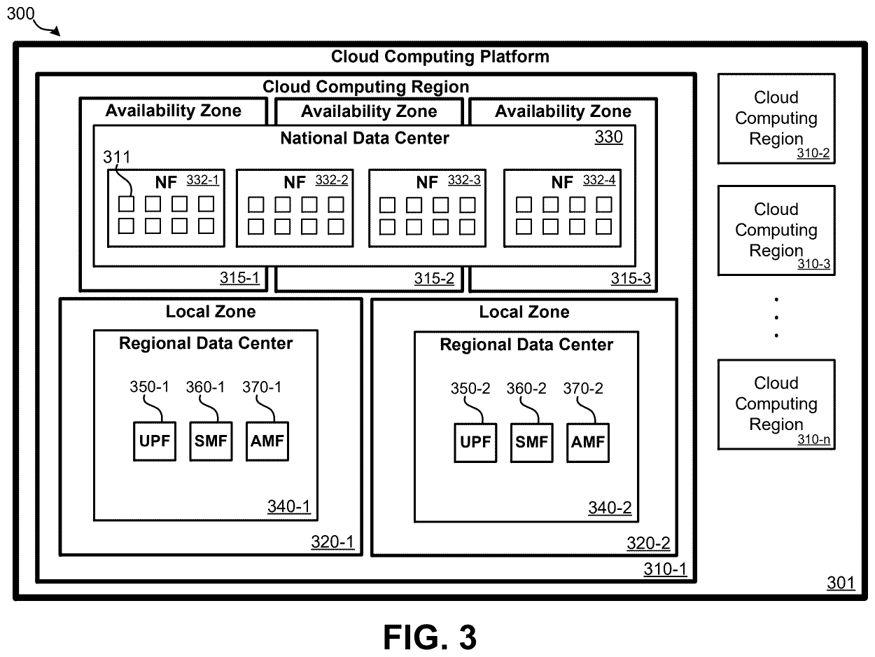

Cellular network core 110 represents the core of the cellular network where various network functions (NFs) are executed. Cellular network core 110 is located remotely from small cell hardware platform 140 and is accessible via some combination of public and private networks. Further detail regarding implementations of cellular network core 110 are provided in relation to FIGS. 2 and 3. In some embodiments, cellular network core 110 is a 5G core. In other embodiments, later generations of cellular network course may be used, such as 6G and beyond. Further, as detailed in relation to FIG. 3, cellular network core 110 can be hosted using a cloud computing system, such as a public cloud computing system that allows many distinct entities to separately utilize storage and processing capabilities of the public cloud computing system.

Network 120 represents a private network, public network, or some combination thereof. Network 120 can be used by small cell hardware platform 142 access and remote services 130. In some embodiments, a private network connection, such as reserved bandwidth on an ISP's fiber network can be used for communication between small cell hardware platform 140 and cellular network core 110. Additionally, or alternatively, communication may occur between small cell hardware platform 140 and cellular network core 110 via the Internet. The network 120, small cell hardware platform 140 may communicate with various entities via the Internet. Such various entities are represented by remote services 130.

Remote services 130 can represent any form of remote server system with which user equipment in communication with small cell hardware platform 140 may need to communicate. Remote services 130 can include: servers hosting websites, cloud computing systems, servers providing email access, servers providing data for applications installed on the UE, servers providing file transfer services, private servers that control UE, gaming servers, etc. Since remote services 130 is accessible by UEs 160 via the Internet, communication between UEs 160 and any of remote services 130 occurs via a UPF, such as UPF 145.

Connected with network 120 is small cell hardware platform 140. As previously noted, a “small cell” refers to a relatively low-powered cellular network radio access node compared to a cellular base station that provides cellular network access over a significant geographic area. Possible uses of a small cell are inside of factories, warehouses, malls, stadiums, public halls, corporate offices. Other possible uses are in dense urban areas, outdoor areas requiring cellular access (e.g., concert venues, sports stadiums), etc. While this document explicitly refers to small cells, it should be understood that the concepts detailed herein can apply to other types of cellular base stations that provide service to varying sized cells or geographic areas.

Small cell hardware platform represents the hardware necessary to perform the functionality of small cell 150 and UPF 145. Small cell hardware platform 140 can include: one or more processors, one or more memories, one or more non-transitory computer readable mediums, one or more cellular radios, and one or more antennas. The housing may be present that houses all or some of the components of small cell hardware platform 140. The housing may be configured to be mounted in a location to provide cellular service to multiple UEs. Small cell hardware platform 140 has at least one wired connection used for accessing network 120.

Small cell 150 includes gNodeB (gNB) functionality. GNB functionality 152 includes various functions that can be logically part of a centralized unit (CU), a distributed unit (DU), and a radio unit (RU). The DU may perform various functions such as scheduling of communications with UEs. The CU may manage radio resource control (RRC) and packet data convergence protocol (PDCP) layers. The RU can include one or more radios used to communicate wirelessly with UEs.

Small cell 150 is configured to route requests to UPF 145 that is hosted by small cell hardware platform 140 instead of a UPF hosted by cellular network core 110. The components of small cell hardware platform 140 may be virtually or physically separated from UPF 145 such that execution of gNB functionality 152 of small cell 150 is not affected by UPF 145. Therefore, if UPF 145 goes off-line, small cell 150 is not affected. Virtual segregation of small cell 150 from UPF 145 can include small cell 150 and UPF 145 being executed by separate virtual machines. Small cell 150 and UPF 145 may have different portions of memory allocated to each other and may have processing resources reserved for each other. Rather than virtually separating UPF 145 from small cell 150, separate hardware may be used for each. For example, UPF 145 may be executed on a separate processor or ARM (Advanced RISC Machine) core from small cell 150. Similarly, separate physical memory may be used for UPF 145 and for small cell 150.

By having small cell 150 and UPF 145 containerized separately, installing, commissioning, updating, and upgrading the UPF can be performed without affecting the gNB functions (e.g., not resetting or restarting) of small cell 150 and vice versa. For example, restarting the gNB when updating UPF software is avoided. In some embodiments, vector packet processor (VPP) and data plane development kit (DPDK) can be used to allocate processing cores appropriately between UPF 145 and small cell 150.

In some embodiments, UPF 145 is configured to allow for a cloud-native implementation. Such an implementation allow for portability, scalability, independence from other applications or platforms, and agility. Such an arrangement can also be referred to as containerization. Once containerized properly, the software of UPF 145 can be deployed in any platform (e.g., Intel, ARM, Linux, ×86, etc.) because of the aforementioned cloud-native properties. In the arrangement of FIG. 1, small cell hardware platform 140 can serve as an edge cloud computing system to host UPF 145.

UEs 160 represent any form of electronic device that communicates wirelessly with small cell 140. UEs 160 can include: smart phones, cellular modems, internet of things (IoT) devices, laptop computers, tablet computers, desktop computers, smart home devices, security equipment, factory equipment, gaming devices, any form of computerized device that uses cellular communications, etc. While three UEs 160 are illustrated, this number is merely representative. Fewer or greater numbers of UEs 160 may be in wireless communication with small cell 150.

UEs 160 communicate wirelessly using a cellular network communication protocol with small cell 150. Such communications may occur via one or more antennas and an RU of small cell 150. Communications not involving Internet access, such as text messaging and phone calls may occur conventionally. Communications involving Internet access, such as any communications involving remote services 130, is routed via UPF 145 hosted locally on the same hardware as small cell 150 by small cell hardware platform 140.

When a UE, such as UE 160-1, is to access a remote service of remote services 130, a communication (e.g., a request for a website) may first be routed to small cell 150. In response to this request, via the N2 interface, a request may be sent to the access and mobility management function (AMF), which still is hosted by the cellular network core 110. The AMF can be used to select the appropriate UPF, which in this case would be UPF 145 for the UE. Via the N3 interface, the communication can be routed to UPF 145 based on the response from the AMF. Then, using the N6 interface, the communication is routed outside of the cellular network via network 120 to a server system of remote services 130 based on the communication. Communications between the server system of remote services 130 and UE 160-1 are then performed via UPF 145, thus not requiring the communications to pass through cellular network core 110.

Cellular network core 110 may also host a UPF, since one or more other cellular base stations may not include their own UPF. If UPF 145 ever goes off-line, the AMF hosted by cellular network core 110 can cause the anchor point of UEs communicating with small cell 150 to be adjusted to one of the UPF's hosted by cellular network core 110. Therefore, if UPF 145 goes off-line, for access to the same network function can be attained via cellular network core 110.

A network slice functions as a virtual network operating on a cellular network, such as the cellular network of system 100. Many network slices may be present simultaneously, such as hundreds or thousands of network slices on the cellular network of system 100. Communication bandwidth and computing resources of the underlying physical network can be reserved for individual network slices, thus allowing the individual network slices to reliably meet particular service level agreement (SLA) levels and parameters. By controlling the location and amount of computing and communication resources allocated to a network slice, the SLA attributes for UEs on the network slice can be varied on different slices. A network slice can be configured to provide sufficient resources for a particular application to be properly executed and delivered (e.g., gaming services, video services, voice services, location services, sensor reporting services, data services, etc.). However, such allocations also account for resource limitations, such as to avoid allocation of an excess of resources to any particular UE group and/or application. Further, a cost may be attached to cellular slices: the greater the amount of resources dedicated, the greater the cost to the user; thus, optimization between performance and cost is desirable. Particular network slices may only be reserved in particular geographic regions.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Referring to system 100, only UE that are authorized to access a particular slice or one of a particular group of slices may be permitted to communicate with small cell 150. For example, within a facility or factory, only equipment previously authorized to access a particular network slice may communicate with small cell 150. A consumer that has cellular network access through the same cellular network provider may not be permitted to access small cell 150 for network access. Of UE permitted to access small cell 150, only a subset of UE may be permitted to use UPF 145. For example, if multiple slices are mapped to small cell 150, only a subset of these multiple slices may be configured to permit use of UPF 145; UEs not associated with such a permitted slice may use a UPF of cellular network core 110.

FIG. 2 illustrates an embodiment of cellular network core 110 (“core 110”). Core 110 can be physically distributed across data centers or located at a central national data center (NDC), such as detailed in relation to FIG. 3, and can perform various core functions of the cellular network. Core 110 can include: network resource management components 250; policy management components 260; subscriber management components 270; and packet control components 280. Individual components may communicate via a bus, thus allowing various components of core 110 to communicate with each other directly. Core 110 is simplified to show some key components. Implementations can involve additional components.

Network resource management components 250 can include: Network Repository Function (NRF) 252 and Network Slice Selection Function (NSSF) 254. NRF 252 can allow 5G network functions (NFs) to register and discover each other via a standards-based application programming interface (API). NSSF 254 can be used by AMF 282 to assist with the selection of a network slice that will serve a particular UE (e.g., UEs 160 of FIG. 1).

Policy management components 260 can include: Charging Function (CHF) 262 and Policy Control Function (PCF) 264. CHF 262 allows charging services to be offered to authorized network functions. Converged online and offline charging can be supported. PCF 264 allows for policy control functions and the related 5G signaling interfaces to be supported.

Subscriber management components 270 can include: Unified Data Management (UDM) 272 and Authentication Server Function (AUSF) 274. UDM 272 can allow for generation of authentication vectors, user identification handling, NF registration management, and retrieval of UE individual subscription data for slice selection. AUSF 274 performs authentication with UEs.

Packet control components 280 can include: Access and Mobility Management Function (AMF) 282 and Session Management Function (SMF) 284. AMF 282 can receive connection-and session-related information from UEs and is responsible for handling connection and mobility management tasks, such as assigning a UPF (e.g., UPF 290 or UPF 145) for a particular UE. SMF 284 is responsible for interacting with the decoupled data plane, creating updating and removing Protocol Data Unit (PDU) sessions, and managing session context with the User Plane Function (UPF).

UPF 290 and UPF 145 of FIG. 1 can be responsible for packet routing and forwarding, packet inspection, quality of service (QoS) handling, and external PDU sessions for interconnecting with a Data Network (DN) (e.g., the Internet) or various access networks 297. UPF 290 of core 290 may not be used for UE of small cell 140 that have been assigned to use UPF 145 as the anchor point for accessing the Internet. However, UPF 290 can be assigned to be used by one or more of UE 160 for load balancing purposes with UPF 145 or if UPF 145 goes offline. In some embodiments, only some UE of UE 160, such as based on assigned slice, use UPF 145, while other UE of UE 160 use UPF 290.

In a virtualized arrangement, specialized software on general-purpose hardware may be used to perform the functions of components of core 110. Functionality of such components can be co-located or located at disparate physical server systems.

Cloud-based cellular network components may be executed on a public third-party cloud-based computing platform or a cloud-based computing platform operated by the same entity that operates the RAN. A cloud-based computing platform may have the ability to devote additional hardware resources to NFs or implement additional instances of such components when requested. A “public” cloud-based computing platform refers to a platform where various unrelated entities can each establish an account and separately utilize the cloud computing resources, the cloud computing platform managing segregation and privacy of each entity's data.

FIG. 3 illustrates an embodiment of a cellular network core network topology 300 as implemented on a public cloud-computing platform, according to certain embodiments. The cellular network core network topology 300 can be an implementation of cellular network core 110 of FIGS. 1 and 2. Cellular network core network topology 300 can represent how logical cellular network groups are distributed across cloud computing infrastructure of cloud computing platform 301. Cloud computing platform 301 can be logically and physically divided up into various different cloud computing regions 310. Each of cloud computing regions 310 can be isolated from other cloud computing regions to help provide fault tolerance, fail-over, load-balancing, and/or stability and each of cloud computing regions 310 can be composed of multiple availability zones, each of which can be a separate data center located in general proximity to each other (e.g., within 600 miles). Further, each of cloud computing regions 310 may provide superior service to a particular geographic region based on physical proximity. For example, cloud computing region 310-1 may have its datacenters and hardware located in the northeast of the United States while cloud computing region 310-2 may have its datacenters and hardware located in California. For simplicity, the details of the cellular network as executed in only cloud computing region 310-1 is illustrated. Similar components may be executed in other cloud computing regions of cloud computing regions 310 (310-2, 310-3, 310-n).

In other embodiments, cloud computing platform 301 may be a private cloud computing platform. A private cloud computing platform may be maintained by a single entity, such as the entity that operates the hybrid cellular network. Such a private cloud computing platform may be only used for the hybrid cellular network and/or for other uses by the entity that operates the hybrid cellular network (e.g., streaming content delivery).

Each of cloud computing regions 310 may include multiple availability zones 315. Each of availability zones 315 may be a discrete data center or group of data centers that allows for redundancy that allows for fail-over protection from other availability zones within the same cloud computing region. For example, if a particular data center of an availability zone experiences an outage, another data center of the availability zone or separate availability zone within the same cloud computing region can continue functioning and providing service. A logical cellular network component, such as a national data center, can be created in one or across multiple availability zones 315. For example, a database that is maintained as part of NDC 330 may be replicated across availability zones 315; therefore, if an availability zone of the cloud computing region is unavailable, a copy of the database remains up-to-date and available, thus allowing for continuous or near continuous functionality.

On a (e.g., public) cloud computing platform, cloud computing region 310-1 may include the ability to use a different type of data center or group of data centers, which can be referred to as local zones 320. For instance, a client, such as a provider of the hybrid cloud cellular network, can select from more options of the computing resources that can be reserved at an availability zone 315 compared to a local zone 320. However, a local zone 320 may provide computing resources nearby geographic locations where an availability zone 315 is not available. Therefore, to provide low latency, certain network components, such as regional data centers 340, can be implemented at local zones 320 rather than availability zones 315. In some circumstances, a geographic region can have both a local zone 320 and an availability zone 315.

In the topology of a 5G NR cellular network, 5G core functions of core 110 can logically reside as part of a national data center (NDC) 330. NDC 330 can be understood as having its functionality existing in cloud computing region 310-1 across multiple availability zones 315. At NDC 330, various network functions, such as NFs 332, are executed. For illustrative purposes, each NF 332, whether at NDC 330 or elsewhere located, can be comprised of multiple sub-components, referred to as pods (e.g., pod 311) that are each executed as a separate process by the cloud computing region 310. The illustrated number of pods 311 is merely an example; fewer or greater numbers of pods 311 may be part of the respective 5G core functions. It should be understood that in a real-world implementation, a cellular network core, whether for 5G or some other standard, can include many more network functions. By distributing NFs 332 across availability zones 315, load-balancing, redundancy, and fail-over can be achieved. In local zones 320, multiple regional data centers 340 can be logically present. Each of regional data centers 340 may execute 5G core functions for a different geographic region or group of RAN components. As an example, 5G core components that can be executed within an RDC, such as RDC 340-1, may be: UPFs 350, SMFs 360, and AMFs 370. While instances of UPFs 350 and SMFs 360 may be executed in local zones 320, SMFs 360 may be executed across multiple local zones 320 for redundancy, processing load-balancing, and fail-over.

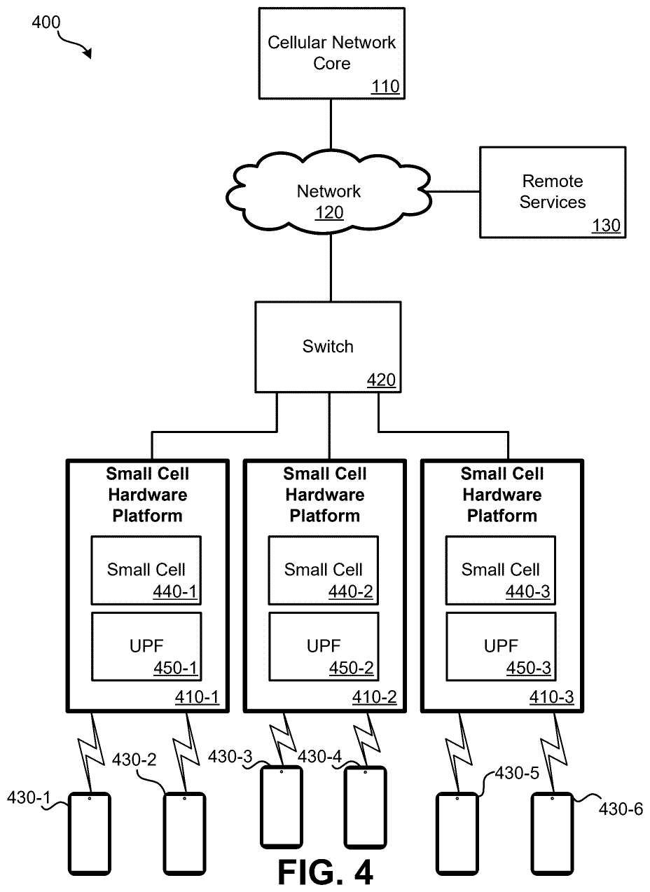

FIG. 4 illustrates an embodiment of a cellular network system (“system 400”) that includes multiple small cells, each having an integrated UPF. System 400 can include: cellular network core 110; network 120; remote services 130; small cell hardware platforms 410; switch 420; and UEs 430. In system 400, each small cell is hosted by a small cell hardware platform that also hosts a UPF. Therefore, as a UE moves between small cells, such as due to physical movement of a UE, cellular network core 110 may reassign which UPF is used as the anchor point for the UE.

The components of small cell hardware platforms 410 may be virtually or physically separated from UPFs 450 such that execution of gNB functionality of small cells 440 is isolated from and not affected by UPFs 450. Therefore, if a UPF of UPFs 450 goes off-line, the co-hosted small cell of small cells 440 is not affected. Virtual isolation or segregation of small cell 440-1 from UPF 450-1 can include small cell 440-1 and UPF 450-1 being executed by separate virtual machines. Small cell 440-1 and UPF 450-1 may have different portions of memory allocated to each other and may have processing resources reserved for each other. Rather than virtually isolating UPF 450-1 from small cell 440-1, separate hardware may be used to achieve isolation. For example, UPF 450-1 may be executed on a separate ARM core from small cell 440-1. Similarly, separate physical memory may be used for UPF 450-1 and for small cell 440-1 to isolated NFs of small cell 440-1 from being affected by UPF 450-1.

Each of small cell hardware platforms 410 are connected with switch 420. Switch 420 serves to connect small cell hardware platforms 410 to network 120, cellular network core 110, and remote services 130. As illustrated, three small cell hardware platforms 410 are illustrated; however, the total number can be greater or fewer based on the geographic region to be covered. For example, in a four-building campus, a separate small cell may be operated for each building.

When a UE, such as UE 430-4, is to access a remote service of remote services 130, a communication (e.g., a request for a website) may first be routed to small cell 440-2. In response to this request, via the N2 interface, a request may be sent to the access and mobility management function (AMF), which is hosted by the cellular network core 110. The AMF can be used to select the appropriate UPF, which in this case can be UPF 450-2. Via the N3 interface, the communication can be routed to UPF 450-2 based on the response from the AMF of cellular network core 110. Then, using the N6 interface, the communication is routed outside of the cellular network via network 120 to a server system of remote services 130 based on the communication. Communications between the server system of remote services 130 and UE 430-4 are then performed via UPF 450-2, thus not requiring the communications to pass through cellular network core 110.

As UE roam among small cells 440, the UPF of UPFs 450 servicing the UE can be adjusted. The AMF of cellular network core 110 can reassign the UPF functioning as the anchor point. For example, if UE 430-1 moved into proximity of small cell 440-3, UPF 450-3 may be assigned to function as the anchor point. In some embodiments, if a UE is being serviced by a non-small cell (e.g., a cellular base station of the cellular network), the AMF may assign a UPF of the cellular network core to serve as the anchor point. Further, the use of a UPF residing at a small cell may not be permitted as the anchor point if a UE roams onto another cellular network. In such a case, a UPF of the cellular network core may be assigned as the anchor point and used for network access by the UE while the UE is roaming. In some embodiments, the UE may remain locked to this anchor point until the UE resumes communication with the cellular network (and, thus, stops roaming).

For load balancing purposes or due to a UPF being unavailable, UE may be assigned to a UPF residing on a another of small cell hardware platform 410. For example, UE 430-4 may be assigned by the AMF of cellular network core 110 to use UPF 450-1 even though UE 430-4 is in wireless communication with small cell 440-2. Communications can be routed from small cell hardware platform 410-2 to UPF 450-1 of small cell hardware platform 410-1 to allow UPF 450-1 to provide functionality for UE 430-4.

For system 400, each of UPFs 450 can use session and service continuity (SSC) mode 3. In mode 3, a connection is established with a new UPF before a connection with a previous UPF is severed. For example, if UE 430-4 is to be switched to using UPF 450-1, a connection between UE 430-4 and UPF 450-1 is established prior to the connection between UE 430-4 and UPF 450-2 being severed.

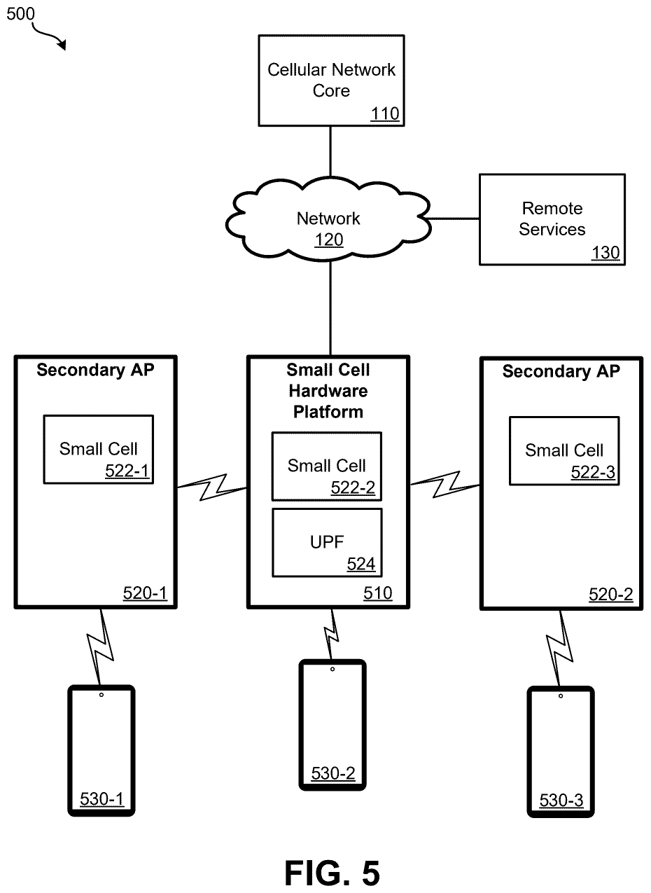

FIG. 5 illustrates an embodiment of a cellular network system (“system 500”) that includes small cell with multiple secondary APs using a UPF integrated with the small cell. System 500 can include: cellular network core 110; network 120; remote services 130; small cell hardware platform 510; secondary access points (APs) 520; and UEs 530. In system 500, small cell hardware platform 510 functions as detailed in relation to small cell hardware platform 140 of FIG. 1.

In system 500, only a single small cell hardware platform 510 with an integrated UPF is present. As illustrated, two additional secondary APs 520 are present. Each secondary AP is in wireless communication with small cell 522-2 of small cell hardware platform 510. Each of UEs 530 can use UPF 524 of small cell hardware platform 510 to access remote services 130.

Small cell 522-2 can communicate with UE via a cellular communication protocol by providing gNodeB for UEs attached with it, such as UE 530-2; and communicate with one or more secondary APs via a cellular communication protocol (function as a gNodeB for the secondary APs by providing wireless backhaul connectivity to the second APs via the cellular communication protocol). Small cell 522-2 can function as a primary access point by aggregating communications for all UE with cellular network core 110.

When a UE, such as UE 530-1, is to access a remote service of remote services 130, a communication (e.g., a request for a website) may first be routed to small cell 522-2, which via a backhaul connection, can get routed to small cell 522-2. In response to this request, small cell 522-2 can send, via the N2 interface, the request to the AMF of cellular network core 110. The AMF can be used to select the appropriate UPF, which in this case could be UPF 524 for UE 530-1. Via the N3 interface, the communication can be routed to UPF 524 based on the response from the AMF. Then, using the N6 interface, the communication is routed outside of the cellular network via network 120 to a server system of remote services 130 based on the communication. Communications between the server system of remote services 130 and UE 530-1 are then performed via UPF 524, thus not requiring the communications to pass through cellular network core 110.

An advantage of using an embodiment similar to system 500 is that secondary APs 520 do not need a wired connection with small cell hardware platform 510. The number of secondary APs 520 can be greater or fewer depending on the geographic area that requires cellular coverage.

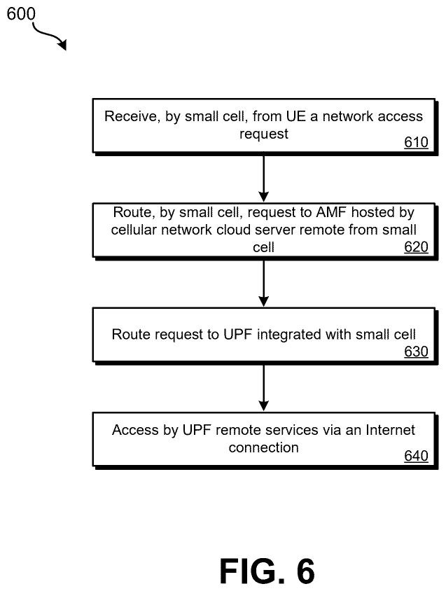

Various methods can be performed using the systems and arrangements detailed in FIGS. 1-5. FIG. 6 illustrates an embodiment of a method 600 for using a small cell with an integrated UPF. Method 600 can be adapted to function in accordance with the alternative architectures of systems 400 and 500 of FIGS. 4 and 5, respectively.

At block 610, a network access request can be received by a cell (e.g., small cell) from a UE. The request is received wirelessly via a cellular network communication protocol and an RU of the small cell, such as 5G NR. The network access request can be an attempt to reach a resource available via the Internet, such as detailed in relation to remote services 130. The request of block 610 is received

At block 620, the cell can route the request from block 610 to an AMF hosted by the cellular network core. The cellular network core is accessible remotely via a network, such as via the Internet. As detailed in relation to FIGS. 2 and 3, the cellular network core can be hosted on a cloud computing platform, which may be a public cloud computing system. Communication between the small cell and the AMF of the cellular network core can occur via the N2 interface. At part of block 620, the AMF may analyze the request and determine to assign the integrated UPF to serve as the anchor point and provide network access for the UE. The AMF may analyze which slice the UE is assigned to and may base the analysis at least in part on the assigned slice. Additional factors can include load balancing and which UPFs are currently available, as previously detailed.

At block 630, based on the AMF analyzing the request received at block 620, the communication of the UE can be routed to the UPF that is hosted by the same small cell hardware platform as the small cell. More generally, as part of block 630, data corresponding to the network access request is received by the UPF that is hosted by the same small cell hardware platform as the small cell from the AMF. As previously detailed, some amount of isolation can be performed to keep the UPF and the NFs of the gNB of the small cell isolated from each other. Once assigned to the integrated UPF, communications between the UE and the UPF do not need to be routed through the cellular network core; rather, such communications are performed locally at the small cell hardware platform. The communication of block 630 between the small cell and the UPF can be performed using the N3 interface.

At block 640, via the UPF, the UE accesses and communicates with the network without communications needing to be routed via the cellular network core. Communication is then performed between the UE and one or more network-accessible resources.

As detailed in relation to FIG. 4, multiple small cells may each have a UPF hosted locally that are used for accessing an Internet connection. These small cell hardware platforms may be each connected with a switch. Alternatively, multiple small cells may share a UPF hosted by a particular small cell hardware platform.

When a UE switches to wirelessly communicating with another base station or small cell, the anchor point may be shifted such that the integrated UPF is no longer used for communication. The AMF of the cellular network core can assign another UPF (or maintain the same UPF) depending on factors such as location, load-balancing, and the slice to which the UE is assigned. For example, if the small cell is operated by a customer of the cellular network, only UEs associated with the customer may be permitted to use the UPF or remain using the UPF as an anchor point when the UE is no longer wirelessly communicating with an RU of the small cell.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A cellular network base station system, comprising:
a cellular base station hardware platform configured to execute:
gNodeB functions; and
a user plane function (UPF), wherein the cellular base station hardware platform is configured to:
execute the UPF in isolation from the gNodeB functions; and
route Internet communications for pieces of user equipment (UEs) in wireless communication with the cellular base station hardware platform via the UPF to the Internet without passing through a cellular network core.

2. The cellular network base station system of claim 1, further comprising the cellular network core hosted remotely from the cellular base station hardware platform, wherein the cellular network core hosts an access and mobility management function (AMF).

3. The cellular network base station system of claim 2, wherein the gNodeB functions communicate via an N2 interface with the AMF in the cellular network core and an N3 interface with the UPF hosted by the cellular base station hardware platform.

4. The cellular network base station system of claim 3, wherein the cellular network core is hosted on a public cloud computing platform.

5. The cellular network base station system of claim 3, wherein a first processor is used for the UPF that is distinct from a second processor used to execute the gNodeB functions.

6. The cellular network base station system of claim 3, wherein a first memory block of the cellular base station hardware platform is defined for the UPF and a second memory block of the cellular base station hardware platform is defined for the gNodeB functions.

7. The cellular network base station system of claim 1, further comprising:
a second cellular base station hardware platform configured to execute:
gNodeB functions; and
a second UPF, wherein the cellular base station hardware platform is configured to:
execute the second UPF in isolation from the gNodeB functions; and
route Internet communications for UEs in wireless communication with the second cellular base station hardware platform via the second UPF to the Internet without passing through the cellular network core.

8. The cellular network base station system of claim 7, wherein the cellular base station hardware platform and the second cellular base station hardware platform communicate with a network via a switch.

9. The cellular network base station system of claim 1, further comprising: a secondary access point, wherein the secondary access point is in wireless communication with the cellular base station hardware platform and accesses the UPF to route Internet communications for one or more UEs in wireless communication with the secondary access point.

10. The cellular network base station system of claim 1, wherein the gNodeB functions of the cellular base station hardware platform are part of a small cell.

11. A method for using a cellular base station hardware platform, the method comprising:
receiving, by a small cell that is hosted by the cellular base station hardware platform, a network access request, wherein the small cell performs gNodeB functions;
routing, by the small cell, the network access request to a cellular network core hosted remotely from the cellular base station hardware platform;
receiving, by a user plane function (UPF) hosted by the cellular base station hardware platform, data corresponding to the network access request from the cellular network core; and
in response to the data corresponding to the network access request, accessing, by the UPF, remote services via an Internet connection without the UPF communicating through the cellular network core.

12. The method of claim 11, wherein the cellular network core comprises an access and mobility management function (AMF).

13. The method of claim 12, wherein routing, by the small cell, the network access request to the cellular network core comprises routing the network access request to the AMF, and receiving the data corresponding to the network access request is received from the AMF of the cellular network core.

14. The method of claim 13, wherein gNodeB functions of the small cell communicate via an N2 interface with the AMF in the cellular network core and an N3 interface with the UPF hosted by the cellular base station hardware platform.

15. The method of claim 11, wherein the cellular network core is hosted on a public cloud computing platform.

16. The method of claim 15, wherein a first processor is used for the UPF that is distinct from a second processor used to execute the gNodeB functions.

17. The method of claim 16, wherein a first memory block of the cellular base station hardware platform is defined for the UPF and a second memory block of the cellular base station hardware platform is defined for the gNodeB functions.

18. The method of claim 11, further comprising:
receiving, by a second small cell that is hosted by a second cellular base station hardware platform, a second network access request, wherein the small cell performs gNodeB functions;
routing, by the second small cell, the network access request to the cellular network core hosted remotely from the cellular base station hardware platform;
receiving, by a second UPF hosted by the second cellular base station hardware platform, second data corresponding to the second network access request from the cellular network core; and
in response to the second data corresponding to the second network access request, accessing, by the second UPF, remote services via the Internet connection without the second UPF communicating through the cellular network core.

19. The cellular network base station system of claim 7, wherein the cellular base station hardware platform and the second cellular base station hardware platform communicate with the Internet connection via a switch.

20. The method of claim 11, further comprising:
communicating, by a secondary access point, with the UPF, wherein the secondary access point is in wireless communication with the cellular base station hardware platform and accesses the UPF to route Internet communications for one or more UEs in wireless communication with the secondary access point.
